(19) United States
(12) Patent Application Publication
(10) Pub. No.: US 2016/0281521 A1
(43) Pub. Date: Sep. 29, 2016

(54) FLOWING MATEFACE SEAL

(71) Applicant: United Technologies Corporation, Hartford, CT (US)

(72) Inventors: Carey Clum, East Hartford, CT (US); Thomas N. Slavens, Vernon, CT (US); Christopher Whitfield, Manchester, CT (US)

(21) Appl. No.: 14/665,808

(22) Filed: Mar. 23, 2015

(51) Int. Cl. F01D 11/00; F16J 15/02

(52) U.S. Cl. CPC F01D 11/005; F16J 15/02; F05D 2240/55; F05D 2220/32

(57) ABSTRACT

Aspects of the disclosure are directed to a first platform, a second platform, a seal arranged between the first platform and the second platform, a first slot in the first platform with unequal seal rates between inner and outer sealing surfaces, and a second slot in the second platform with unequal seal rates between the inner and outer sealing surfaces, wherein the seal is configured to be positioned in the inner or outer sealing surfaces based on a ratio of a first pressure associated with a first flow to a second pressure associated with a second flow.

### BACKGROUND

In connection with an aircraft engine, a loss of a flow of air into a path (e.g., a gas-path) of a turbine has a negative effect on engine fuel burn, performance/efficiency, and component life. Seals are commonly used to limit leakage of flow between segmented or full-hoop turbine components.

The turbine includes vanes or blades that interface to one another. This interface is subject to distress, due at least in part to elevated temperatures or temperature gradients. Techniques for reducing/eliminating this distress are needed in order to extend turbine component/device lifetimes.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system associated with an engine of an aircraft, comprising: a first platform, a second platform, a seal arranged between the first platform and the second platform, a first slot in the first platform with unequal seal rates between inner and outer sealing surfaces, and a second slot in the second platform with unequal seal rates between the inner and outer sealing surfaces, wherein the seal is configured to be positioned in the inner or outer sealing surfaces based on a ratio of a first pressure associated with a first flow to a second pressure associated with a second flow. In some embodiments, the system further comprises a first stand-off associated with the first platform, and a second stand-off associated with the second platform. In some embodiments, the seal contacts the first stand-off and the second stand-off when the ratio is greater than a threshold. In some embodiments, the seal contacts a surface of at least one of the first platform or the second platform when the ratio is less than the threshold. In some embodiments, the threshold is approximately equal to one. In some embodiments, the first flow comprises a non-working fluid flow and the second flow comprises a combustion gas flow. In some embodiments, the non-working fluid flow comprises a cooling flow. In some embodiments, the system further comprises a third stand-off associated with the first platform. In some embodiments, the system further comprises a fourth stand-off associated with the second platform. In some embodiments, the first platform includes a first plurality of stand-offs, and a density of first plurality of stand-offs is substantially uniform over a longitudinal direction of the first slot in the first platform. In some embodiments, the first platform is associated with a first vane and a first blade of a turbine. In some embodiments, the second platform is associated with a second vane and a second blade of the turbine. In some embodiments, at least one of the first platform or the second platform is associated with a blade outer air seal. In some embodiments, at least one of the first platform or the second platform is associated with a combustor panel. In some embodiments, the first stand-off is shaped as at least one of a square, a rectangle, a circle, an oval, or a triangle. In some embodiments, the first stand-off is added to the first platform using an additive manufacturing technique. In some embodiments, the first stand-off is provided based on an application of a grinding or abrasive technique to the first platform. In some embodiments, the first stand-off is provided based on an application of a chemical etching technique to the first platform.

### BRIEF DESCRIPTION OF THE DRAWINGS

The present disclosure is illustrated by way of example and not limited in the accompanying figures in which like reference numerals indicate similar elements.

FIG. 1 is a side cutaway illustration of a geared turbine engine.

FIG. 2A illustrates a platform incorporating a vane and a blade in accordance with the prior art.

FIG. 2B illustrates a front view of a system incorporating a first vane/blade platform and a second vane/blade platform under conditions associated with a first operative scenario in accordance with the prior art.

FIG. 2C illustrates a side view of one of the platforms of FIG. 2B in accordance with the prior art.

FIG. 2D illustrates a front view of the system of FIG. 2B under conditions associated with a second operative scenario in accordance with the prior art.

FIG. 2E illustrates a side view of one of the platforms of FIG. 2D in accordance with the prior art.

FIG. 3A illustrates a platform incorporating a vane and a blade in accordance with aspects of the disclosure.

FIG. 3B illustrates a front view of a system incorporating a first vane/blade platform and a second vane/blade platform under conditions associated with a first operative scenario in accordance with aspects of the disclosure.

FIG. 3C illustrates a side view of one of the platforms of FIG. 3B in accordance with aspects of the disclosure.

FIG. 3D illustrates a front view of the system of FIG. 3B under conditions associated with a second operative scenario in accordance with aspects of the disclosure.

FIG. 3E illustrates a side view of one of the platforms of FIG. 3D in accordance with aspects of the disclosure.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, apparatuses, systems and methods are described for providing a seal or sealing interface between two or more platforms. In some embodiments, a position of a seal is determined based on a ratio of a cooling air pressure to a combustion gas pressure. For example, when the ratio is greater than a threshold value a seal (e.g., a feather seal) may assume a first position and when the ratio is less than the threshold value the seal may assume a second position.

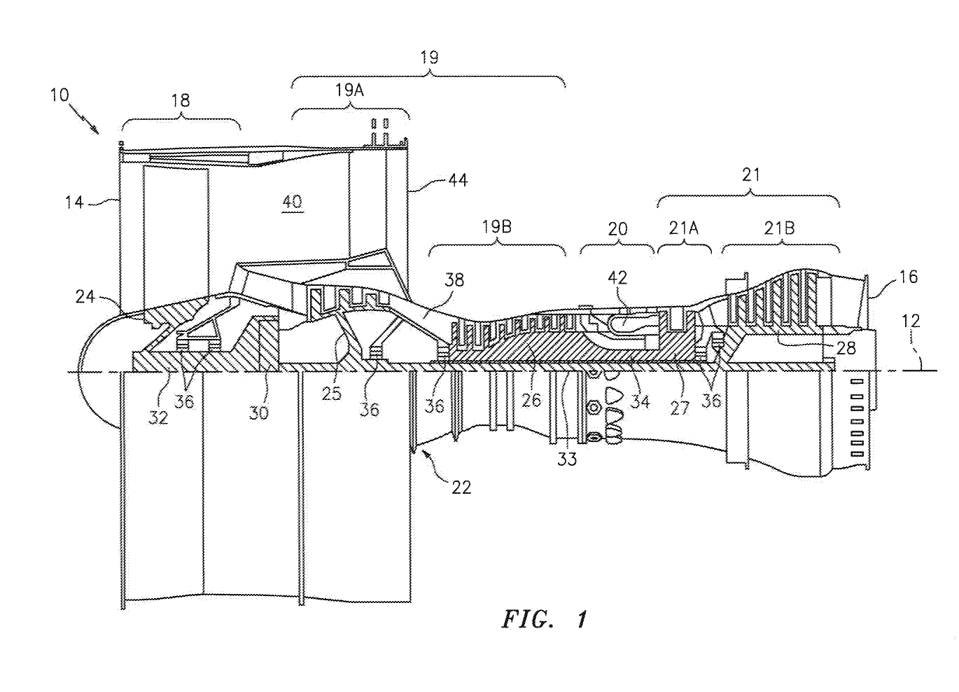

Aspects of the disclosure may be applied in connection with a gas turbine engine. FIG. 1 is a side cutaway illustration of a geared turbine engine 10. This turbine engine 10 extends along an axial centerline 12 between an upstream airflow inlet 14 and a downstream airflow exhaust 16. The turbine engine 10 includes a fan section 18, a compressor section 19, a combustor section 20 and a turbine section 21. The compressor section 19 includes a low pressure compressor (LPC) section 19A and a high pressure compressor (HPC) section 19B. The turbine section 21 includes a high pressure turbine (HPT) section 21A and a low pressure turbine (LPT) section 21B.

The engine sections 18-21 are arranged sequentially along the centerline 12 within an engine housing 22. Each of the engine sections 18-19B, 21A and 21B includes a respective rotor 24-28. Each of these rotors 24-28 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 24 is connected to a gear train 30, for example, through a fan shaft 32. The gear train 30 and the LPC rotor 25 are connected to and driven by the LPT rotor 28 through a low speed shaft 33. The HPC rotor 26 is connected to and driven by the HPT rotor 27 through a high speed shaft 34. The shafts 32-34 are rotatably supported by a plurality of bearings 36; e.g., rolling element and/or thrust bearings. Each of these bearings 36 is connected to the engine housing 22 by at least one stationary structure such as, for example, an annular support strut.

During operation, air enters the turbine engine 10 through the airflow inlet 14, and is directed through the fan section 18 and into a core gas path 38 and a bypass gas path 40. The air within the core gas path 38 may be referred to as “core air”. The air within the bypass gas path 40 may be referred to as “bypass air”. The core air is directed through the engine sections 19-21, and exits the turbine engine 10 through the airflow exhaust 16 to provide forward engine thrust. Within the combustor section 20, fuel is injected into a combustion chamber 42 and mixed with compressed core air. This fuel-core air mixture is ignited to power the turbine engine 10. A portion of compressed core air may be diverted away from the combustion chamber 42 and used to cool gaspath hardware associated with the HPT section 21A. This compressed core air that is not mixed with fuel and combusted in the combustion chamber 42 may be referred to as a “coolant flow”. The bypass air is directed through the bypass gas path 40 and out of the turbine engine 10 through a bypass nozzle 44 to provide additional forward engine thrust. This additional forward engine thrust may account for a majority (e.g., more than 70 percent) of total engine thrust. Alternatively, at least some of the bypass air may be directed out of the turbine engine 10 through a thrust reverser to provide reverse engine thrust.

FIG. 1 represents one possible configuration for an engine 10. Aspects of the disclosure may be applied in connection with other environments, including additional configurations for an engine of an aircraft.

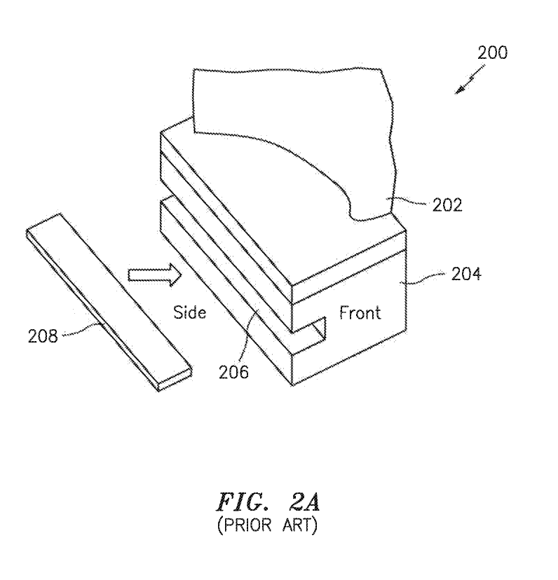

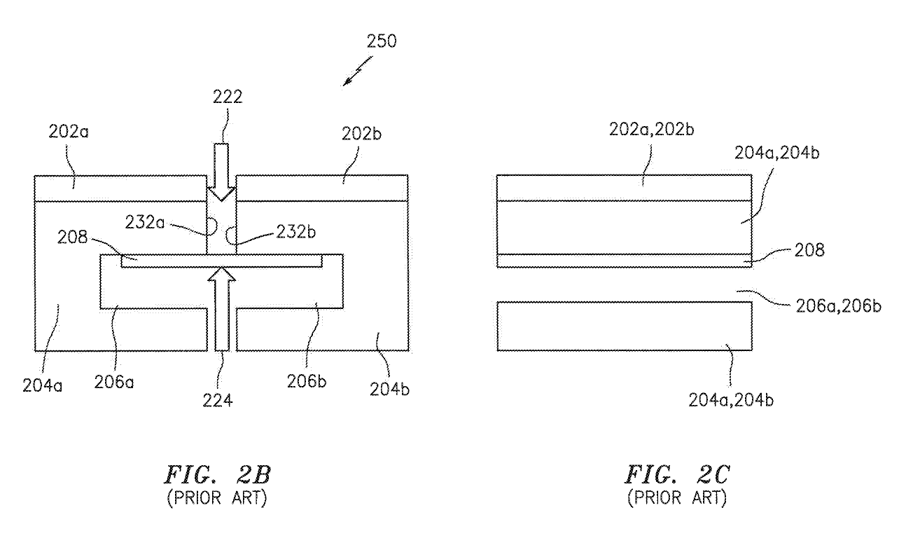

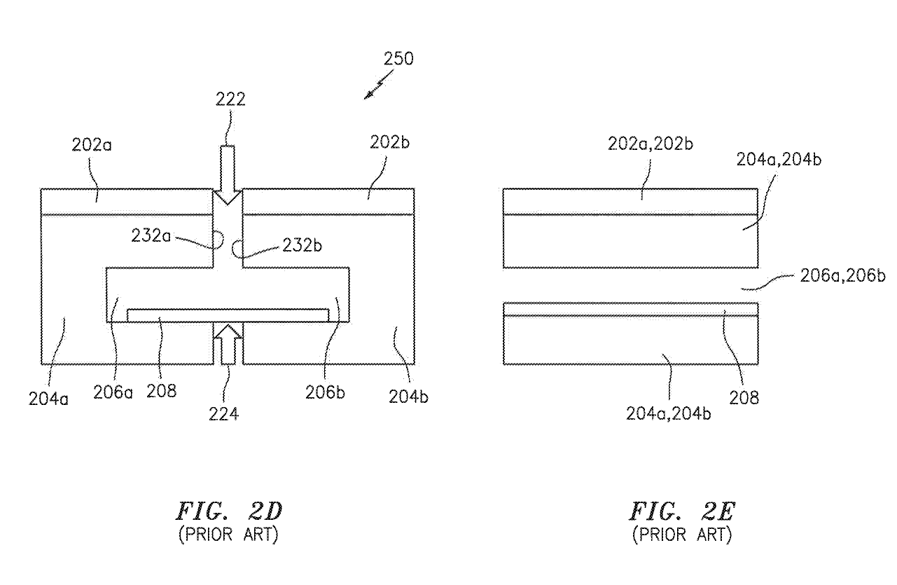

Referring now to FIG. 2A, a vane 200 in accordance with the prior art is shown. The vane 200 is part of a turbine (e.g., turbine section 21). The vane 200 includes an airfoil 202 coupled to a platform 204. The platform 204 includes a slot 206 that is configured to seat or accommodate a seal 208. The seal 208 is frequently referred to as a feather seal in the art.

Superimposed in FIG. 2A are the descriptors “front” and “side” to refer to first and second ends of the platform 204. These terms are used throughout herein simply for the sake of convenience in illustration and description.

Referring to FIG. 2B, a system 250 in accordance with the prior art is shown. The system 250 incorporates aspects of the vane 200. For example, the system 250 includes a first platform (platform 204a) and a second platform (platform 204b). The seal 208 interfaces or bridges the platforms 204a and 204b via slots 206a and 206b as shown. The platforms 204a and 204b are shown with coatings 202a and 202b, respectively.

Superimposed in FIG. 2B is an arrow 222 that is representative of a gaspath flow that may be associated with the “core air” described above. Also shown is an arrow 224 that is representative of a “coolant flow” as described above.

The position or location of the seal 208 at the top of the slots 206a and 206b in FIG. 2B is based on a ratio of: (1) the pressure of the coolant flow 224, to (2) the pressure of the gaspath flow 222, being greater than one (e.g., the pressure of the coolant flow 224 is greater than the pressure of the gaspath flow 222). In such a scenario, mateface surfaces 232a and 232b of the platforms 204a and 204b, respectively, may be subjected to elevated temperatures associated with the gaspath flow 222. Such exposure, over time, can lead to excessive wear/fatigue of the surfaces 232a and 232b.

Whereas FIG. 29 represents a front view, FIG. 2C represents a side view for one of the first and second platforms 204a and 204b described above in connection with the system 250 of FIG. 2B.

Referring now to FIG. 2D, the system 250 is shown again. In contrast to FIG. 2B, the scenario depicted in FIG. 2D entails the ratio of: (1) the pressure of the coolant flow 224, to (2) the pressure of the gaspath flow 222, being less than one (e.g., the pressure of the coolant flow 224 is less than the pressure of the gaspath flow 222). In such a scenario, the seal 208 is positioned or located at the bottom of the slots 206a and 206b in FIG. 2D. Such a positioning of the seal 208 generally precludes the gaspath flow 222 from traveling into a coolant cavity (e.g., the area/region below the platforms 204a and 204b in FIG. 2D).

Whereas FIG. 2D represents a front view, FIG. 2E represents a side view for one of the first and second platforms 204a and 204b described above in connection with the system 250 of FIG. 2D.

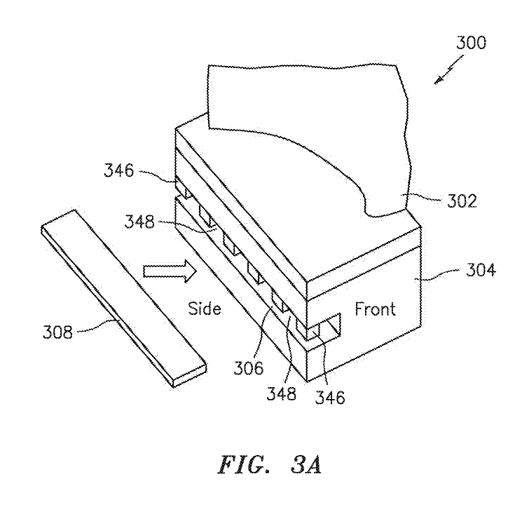

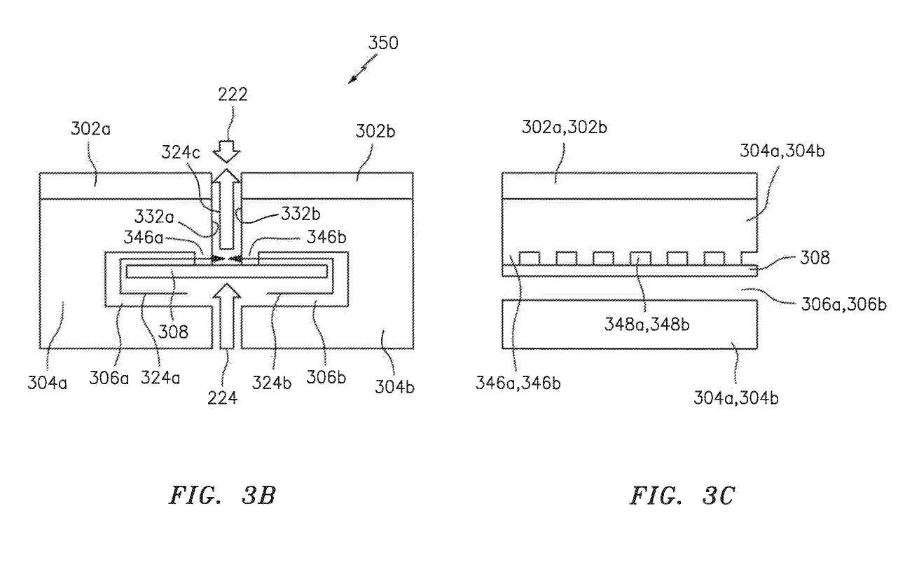

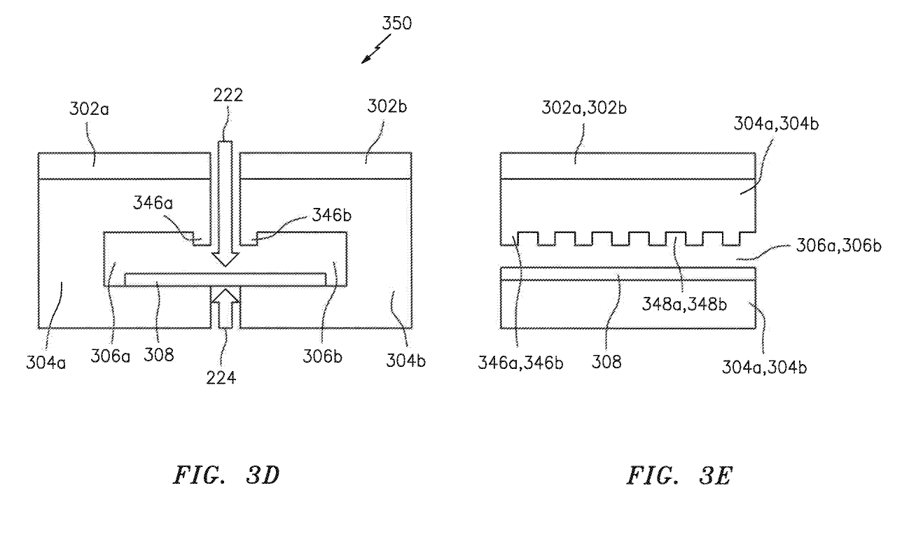

Referring now to FIG. 3A, a vane 300 in accordance with aspects of the disclosure is shown. The vane 300 may be effective in countering the impact of the elevated temperatures associated with the gaspath flow 222 on mateface surfaces described above in connection with FIGS. 29-2C for reasons that will become clearer below.

The vane 300 may be part of a turbine (e.g., turbine section 21). The vane 300 may include an airfoil 302 coupled to a platform 304. The platform 304 may include a slot 306 that may be configured to seat or accommodate a seal 308. The terms “front” and “side” are carried forward in FIG. 3A in the same manner as described above in connection with, e.g., FIG. 2A.

The vane 300 may be similar to the vane 200. However, at least one difference between the two vanes is that the vane 304 may be manufactured/fabricated to include one or more stand-offs 346.

In some embodiments, the stand-offs 346 may be added to the platform 304. For example, the stand-offs 346 may be included as part of an additive manufacturing technique applied to the platform 304.

In some embodiments, the stand-offs 346 may be provided in connection with the platform 304 based on applying a grinding or abrasive technique to the platform 304. For example, material associated with the platform 304 may be removed in the location of gaps 348 between the stand-offs 346, such that a sequence of stand-offs 346 and gaps 348 is created as shown in, e.g., FIG. 3A. In some embodiments, the material removal to create the gaps 348 may be based on an application of one or more chemicals to the platform 304 in the locations of the gaps 348. The application of such chemical(s) may entail the use of a chemical etching technique.

The form factor for the stand-offs 346 (or analogously, the gaps 348) may be customized. Any number of shapes or configurations may be used, including for example squares, rectangles, circles, ovals, triangles, etc. The density of the stand-offs 346 or the gaps 348 may be substantially uniform/constant or non-uniform over a given dimension/length of the platform 304.

Referring to FIG. 3B, a system 350 in accordance with aspects of the disclosure is shown. The system 350 incorporates aspects of the vane 300. For example, the system 350 includes a first platform (platform 304a) and a second platform (platform 304b). The seal 308 interfaces or bridges the platforms 304a and 304b via slots 306a and 306b as shown. The platforms 304a and 304b are shown with coatings 302a and 302b, respectively.

The platform 304a may include one or more stand-offs, denoted as rerence character 346a in FIG. 3B. A mateface surface of the platform 304a is identified as reference character 332a.

The platform 304b may include one or more stand-offs, denoted as reference character 346b in FIG. 3B. A mateface surface of the platform 304b is identified as reference character 332b.

Similar to the scenario described above in connection with FIG. 2B, the scenario depicted in FIG. 3B may be based on a ratio of: (1) the pressure of the coolant flow 224, to (2) the pressure of the gaspath flow 222, being greater than one (e.g., the pressure of the coolant flow 224 is greater than the pressure of the gaspath flow 222). In contrast to the scenario depicted in FIG. 2B, however, in FIG. 3B the seal 308 might not be positioned/located at the (very) top of the slots 306a and 306b. Instead, in FIG. 3B the seal 308 may be prevented from being located at the (very) top of the slots 306a and 306b by the stand-offs 346a and 346b, respectively, in an amount equal to the height/dimension of the stand-offs 346a and 346b. In this respect, the seal 308 may contact at least one of the stand-off 346a or the stand-off 346b.

As a result of the use of the stand-offs 346a and 346b, at least a portion of the coolant flow 224 can flow around the seal 308 and up through the gap between the mateface surfaces 332a and 332b as reflected via the arrows 324a, 324b, and 324c. These flows 324a, 324b, and 324c may be used to cool the mateface surfaces 332a and 332b and provide a coolant flow out of the gap between the mateface surfaces 332a and 332b. In this manner, the platforms 304a and 304b might not be subjected to the same elevated temperatures that are experienced by the platforms 204a and 204b, or more precisely, the impact of such elevated temperatures may be mitigated by the presence of flows 324a, 324b, and 324c.

Whereas FIG. 3B represents a front view, FIG. 3C represents a side view for one of the first and second platforms 304a and 304b described above in connection with the system 350 of FIG. 3B. The gaps 348a, 348b may enable/facilitate the flow of one or more of the coolant flows 324a, 324b, or 324c described above.

Referring now to FIG. 3D, the system 350 is shown again. In contrast to FIG. 3B, the scenario depicted in FIG. 3D may entail the ratio of: (1) the pressure of the coolant flow 224, to (2) the pressure of the gaspath flow 222, being less than one (e.g., the pressure of the coolant flow 224 is less than the pressure of the gaspath flow 222). In such a scenario, the seal 308 may be positioned or located at the bottom of the slots 306a and 306b in FIG. 3D, such that the seal 308 may contact a surface of at least one of the platform 304a or the platform 304b. Such a positioning of the seal 308 may generally preclude the gaspath flow 222 from traveling into a coolant cavity (e.g., the area/region below the platforms 304a and 304b in FIG. 3D).

Whereas FIG. 3D represents a front view, FIG. 3E represents a side view for one of the first and second platforms 304a and 304b described above in connection with the system 350 of FIG. 2D.

Some of the examples described above in connection with FIGS. 3B-3E based a position of the seal 308 within the slot 306 (or analogously, the slots 306a and 306b) on whether the ratio of: (1) the pressure of the coolant flow 224, to (2) the pressure of the gaspath flow 222, was greater than or less than one. One skilled in the art will appreciate based on a review of this disclosure that any threshold value may be used. In other words, a value of one (or approximately one) is merely one example of a threshold that may be used.

While some of the examples described herein related to platforms that are associated with vanes or blades, aspects of the disclosure may be used in connection with other application environments. For example, aspects of the disclosure may he applied in connection with a blade outer air seal (BOAS), a combustor panel, etc.

Technical effects and benefits of this disclosure include an enhancement or extension of one or more component or device lifetimes.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

What is claimed is:

1. A system associated with an engine of an aircraft, comprising:
a first platform;
a second platform;
a seal arranged between the first platform and the second platform;
a first slot in the first platform with unequal seal rates between inner and outer sealing surfaces; and
a second slot in the second platform with unequal seal rates between the inner and outer sealing surfaces,
wherein the seal is configured to be positioned in the inner or outer sealing surfaces based on a ratio of a first pressure associated with a first flow to a second pressure associated with a second flow.

2. The system of claim 1, comprising:
a first stand-off associated with the first platform; and
a second stand-off associated with the second platform.

3. The system of claim 2, wherein the seal contacts the first stand-off and the second stand-off when the ratio is greater than a threshold.

4. The system of claim 1, wherein the seal contacts a surface of at least one of the first platform or the second platform when the ratio is less than the threshold.

5. The system of claim 4, wherein the threshold is approximately equal to one.

6. The system of claim 1, wherein the first flow comprises a non-working fluid flow and the second flow comprises a combustion gas flow.

7. The system of claim 6, wherein the non-working fluid flow comprises a cooling flow.

8. The system of claim 2, further comprising:
a third stand-off associated with the first platform.

9. The system of claim 8, further comprising:
a fourth stand-off associated with the second platform.

10. The system of claim 1, wherein the first platform includes a first plurality of stand-offs, and wherein a density of first plurality of stand-offs is substantially uniform over a longitudinal direction of the first slot in the first platform.

11. The system of claim 1, wherein the first platform is associated with a first vane and a first blade of a turbine.

12. The system of claim 11, wherein the second platform is associated with a second vane and a second blade of the turbine.

13. The system of claim 1, wherein at least one of the first platform or the second platform is associated with a blade outer air seal.

14. The system of claim 1, wherein at least one of the first platform or the second platform is associated with a combustor panel.

15. The system of claim 2, wherein the stand-off is shaped as at least one of a square, a rectangle, a circle, an oval, or a triangle.

16. The system of claim 2, wherein the first stand-off is added to the first platform using an additive manufacturing technique.

17. The system of claim 2, wherein the first stand-off is provided based on an application of a grinding or abrasive technique to the first platform.

18. The system of claim 2, wherein the first stand-off is provided based on an application of a chemical etching technique to the first platform.
